(19) United States
(12) Patent Application Publication
(10) Pub. No.: US 2022/0212419 A1
(43) Pub. Date: Jul. 7, 2022

(54) Structural Web

(71) Applicant: LENTUS COMPOSITES LIMITED, Banbury Oxfordshire (GB)

(72) Inventors: MICHAEL DEWHIRST, Eynsham Oxfordshire (GB); PAUL LEWIS, Eynsham Oxfordshire (GB)

(21) Appl. No.: 17/608,049

(22) PCT Filed: May 1, 2020
(86) PCT No.: PCT/EP2020/062214

§ 371 Date: Nov. 1, 2021

(30) Foreign Application Priority Data
May 3, 2019 (GB) 1906323.9

(51) Int. Cl. B29C 70/08; B29C 70/22; B29C 70/24; B29C 70/44

(52) U.S. Cl. CPC B29C 70/085; B29C 70/446; B29C 70/24; B29C 70/222

(57) ABSTRACT

A structural web having a fabric material element 20 that has been stitched or embroidered with a reinforcing fiber 24, the fabric material element 20 defining a peripheral region 28a, 30a, and the reinforcing fiber 24 extending onto the peripheral region 28a,30a, the fabric material element 20 and reinforcing fiber 24 being bent to take on a non-planar form with the peripheral region 28a, 30a angled to a main plane of the element 20 to define an engagement face for cooperation with another component 12, 14, and upon which at least part of the reinforcing fiber 24 is located.

This invention relates to a structural web connected to, for example, a hub and/or an outer rim to form a wheel, gear, connecting flange, brake or clutch disc or the like, and in particular to a structural web of a composite material.

Composite materials are in increasingly widespread use as they are of relatively low cost and are of relatively low weight, but have good strength and load transmitting properties. One area in which it is desirable to be able to employ composite materials is in the manufacture of gears, the relatively low weight resulting not only in weight saving benefits which may be advantageous in certain applications such as aerospace applications, but also results in the gears being of relatively low inertia. Consequently, gear trains or the like employing such gears may be of enhanced responsiveness to changes in input loads.

One way in which composite materials may be incorporated into gears is to use a composite material as a structural web interconnecting a central part of the gear such as a hub thereof and a peripheral rim which may be of, for example, metallic form and may be shaped to define a series of gear teeth.

It is an object of the invention to provide a structural web of a composite material suitable for use in such applications. Whilst the description herein relates primarily to gears and to the incorporation of composite materials into gears, it will be appreciated that the invention is not restricted in this regard and may be employed in a range of other applications in which a structural web is required to be mounted upon or between, for example, an inner hub and/or an outer element or rim. As set out hereinbefore, such structures may be used in a range of applications including wheels, flanges, clutch or brake discs and the like.

According to the invention there is provided a structural web comprising a fabric material element that has been stitched or embroidered with a reinforcing fibre, the fabric material element defining a peripheral region, and the reinforcing fibre extending onto the peripheral region, the fabric material element and reinforcing fibre being bent to take on a non-planar form with the peripheral region angled to a main plane of the element to define an engagement face for cooperation with another component, and upon which at least part of the reinforcing fibre is located.

It will be appreciated that, in such an arrangement, where the peripheral region is adjacent the outer periphery of the element, the reinforcing fibre on the peripheral region may cooperate with an inwardly facing surface of an outer ring or rim component carried by the structural web, in use, enhancing the transmission or transfer of loads between the outer ring or rim component and the structural web.

Where the peripheral region is located adjacent inner periphery of the element, the reinforcing fibre on the peripheral region may cooperate with an outwardly facing surface of an inner hub or the like, thereby enhancing load transmission or transfer between the structural web and the inner hub or the like located at the inner periphery.

The reinforcing fibre may extend over both an inner peripheral region and an outer peripheral region of the element. In such an arrangement, the reinforcing fibre may serve to enhance load transmission or transfer between, for example, an outer ring or rim and an inner hub or the like.

The fabric material element may be of single layer form. However, it preferably comprises a plurality of layers stacked upon one another, each layer preferably being stitched or embroidered as set out hereinbefore. In such an arrangement, the reinforcing fibres stitched or embroidered onto each layer may cooperate with an outer ring and/or inner hub or the like, and so a relatively large area of contact between reinforcing fibres of the structural web and the outer ring and/or inner hub may be formed, enhancing load transmission into the structural web.

The reinforcing fibre may extend in a generally radial direction of the element, resulting in the structural web being of enhanced ability to react generally radially directed loads. It will be appreciated, however, that this represents just one example direction in which the reinforcing fibre may extend, and that it may be arranged to extend in other directions depending upon the application in which the structural web is to be employed, and the loads to be reacted thereby.

Whilst references are made herein to the presence of a reinforcing fibre, it will be appreciated that a plurality of such fibres may be present.

The reinforcing fibre may additionally be stitched or embroidered in a pattern defining a ring located, for example, adjacent the inner or outer periphery of a plurality of layers of the element. Fibres orientated in this direction enhance the ability of the structural web to transmit or transfer generally tangentially directed loads.

The reinforcing fibre may be of a material selected depending upon the application in which the invention is to be employed. By way of example, it may be of carbon fibre, glass fibre, aramid, natural fibre or ceramic material form or the like.

The invention also relates to a method of manufacture of a structural web comprising locating a fabric material element within a mould, the fabric material element having been stitched or embroidered with a reinforcing fibre, the fabric material element defining a peripheral region, and the reinforcing fibre extending onto the peripheral region, and bending the fabric material element to take on a non-planar form with the peripheral region angled to a main plane of the element to define an engagement face for cooperation with another component, and upon which at least part of the reinforcing fibre is located.

The invention will further be described, by way of example, with reference to the accompanying drawings, in which:

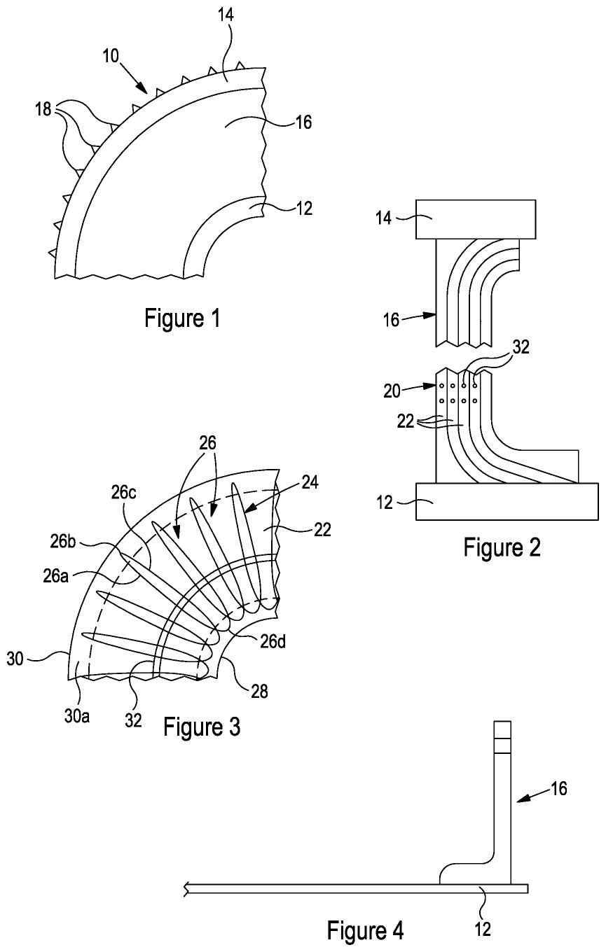

FIG. 1 is a diagrammatic view illustrating a gear in accordance with an embodiment of the invention;

FIG. 2 is a diagrammatic sectional view illustrating part of the gear of FIG. 1;

FIG. 3 is a diagrammatic representation of part of the gear of FIG. 1; and

FIG. 4 is a view illustrating an alternative embodiment of the invention.

Referring firstly to FIGS. 1 to 3, a gear 10 is illustrated comprising a central hub 12, an outer ring 14, and a structural web 16 interconnecting the hub 12 and the ring 14. The hub 12 and ring 14 are of metallic materials, for example steel. The ring 14 is provided, on its outer peripheral surface with a series of gear teeth 18 arranged to mesh, in use, with gear teeth formations of another gear or of another component. The hub 12, in this embodiment, is designed in such a manner as to allow the gear 10 to be mounted upon another component and supported for rotation relative thereto. It will be appreciated, however, that depending upon the application in which the invention is used, the hub 12 may take a range of other forms. By way of example, it may be designed in such a manner as to allow rigid mounting of the gear 10 upon a shaft or the like, or it may itself include gear teeth formations for toothed engagement with another component. It could comprise part of a shaft, if desired.

The structural web 16 is of a composite material form, and comprises a fabric material element 20 made up of a plurality of layers 22 of a fabric material each of which is stitched or embroidered with a reinforcing fibre material 24 such as carbon fibre or glass fibre. As best shown in FIGS. 2 and 3, the reinforcing fibre material 24 is stitched or embroidered upon a face of each layer 22 of the element 20 in a pattern defining a series of generally radially extending loops 26. Each loop 26 includes a first run 26a which extends substantially radially between an inner periphery 28 and an outer periphery 30 of the element 20, a first turn 26b which is located upon an outer peripheral region 30a close to the outer periphery 30, a second run 26c that extends substantially radially between the outer periphery 30 and the inner periphery 28, and a second turn 26d located upon an inner peripheral region 28a adjacent the inner periphery 28. As shown in FIG. 3, the loops 26 are angularly spaced around the element 20.

The location of the turns 26b, 26d adjacent the inner and outer peripheries 28, 30 of the layer 22 ensure that the reinforcing fibre material 24 extends onto the inner and outer peripheral regions 28a, 30a of the layer 22.

In addition, the layers 22 of the element 20 are stitched or embroidered with further reinforcing fibre material 32 in a series of circles or hoops 34 located adjacent the inner periphery 28 and adjacent the outer periphery 30 thereof.

The stitched or embroidered element 20 made up of a stack of stitched or embroidered layers 22 is impregnated or infused with a resin material and placed within a compression mould, and the resin material is cured or allowed to cure with the structural web 16 taking substantially the shape defined by the mould. The compression of the element 20 within the mould serves to consolidate the fibres 24. It also, importantly, serves to bend the layers 22 of the element 20 to result in the inner and outer peripheral regions 28a, 30a being angled to a main plane of each layer 22 with the stitched face of each layer 22 orientated to present the reinforcing fibre 24 located thereon towards the hub 12 or rim 14. The angling of the inner and outer peripheral regions 28a, 30a conveniently forms approximately 90° bends in the layers 22. The finished structural web 16 thus includes generally tubular parts at its inner and outer peripheries, at which the reinforcing fibre 24 of each layer 22 is presented for cooperation with a hub 12 or rim 14 fitted, in use, thereto.

The nature of the curing process may depend upon the resin material used. By way of example, it may require heating of the resin material to be undertaken. It will be appreciated that the nature of the manner in which the resin is cured is not of relevance to the invention and so will not be described herein in further detail. The cured structural web 16, after finishing/machining to required dimensions, is press fitted to the hub 12 and outer ring 14. By way of example, these components may be provided with a series of small spline teeth, sometimes referred to as microsplines, which, during the press fitting process, dig into the material of the structural web 16, resulting in the formation of a good, rigid connection between the structural web 16 and the hub 12 and outer ring 14.

In use, loads are transmitted or transferred into the structural web 16 from the outer ring 14. The loops 26 of the reinforcing fibre 24 serve to transmit or transfer the loads efficiently to the hub 12. As the turns 26b, 26d of the loops 26 provided upon the inner and outer peripheral regions 28a, 30a are presented towards the hub 12 and rim 14 and are located very close to or engage with the hub 12 and outer ring 14, it will be appreciated that the transfer or transmission of loads into the fibre 24 is effective. In the arrangement shown in which the runs 26a, 26c of the loops 26 of the reinforcing fibre 24 extend substantially radially, it will be appreciated that the reinforcing fibre 24 is particularly efficient at bearing or reacting radial loads.

As the reinforcing fibre 24 is stitched upon each of the layers 22, it will be appreciated that the bending and shaping of the element 20 that takes place during the moulding operation results in a significant interface area being formed over which engagement or cooperation between the reinforcing fibre 24 and the hub 12 and/or rim 14 occurs, the size of which can be controlled by appropriate shaping of the mould. Different sizes of interface area may be present at the inner and outer peripheries of the structural web 16, if desired.

Whilst an arrangement in which the loops 26 extend generally radially is illustrated, the fibres may extend in other directions, and so may be of benefit in transmitting or reacting loads directed in other directions. In addition, as mentioned hereinbefore, hoop fibres may be present to enhance the ability of the structural web 16 to transmit loads directed in substantially the tangential direction. Furthermore, these fibres may serve to enhance the hoop strength of the structural web 16, enhancing the ability of the structural web 16 to react the loads arising from the press fitting of the hub 12 and rim 14 thereto. It will be appreciated that the structural web 16 described hereinbefore enables a gear to be formed, a significant part of which is of a composite material. Consequently, a number of the benefits of using composite materials may be gained. The use of a stitched or embroidered composite material is advantageous in that manufacture can be undertaken in a relatively low cost manner, the manufacturing processes used enabling mass manufacture of components of a range of sizes in a convenient and economic manner.

Whilst the description hereinbefore is of the use of the structural web 16 as part of a gear, it will be appreciated that the invention may be employed in other applications. By way of example, FIG. 4 illustrates the structural web 16 in a connecting flange mounted upon a shaft, the flange including openings to allow connection of the flange to another component using bolts or other suitable fasteners. The stitching or embroidering of the reinforcing fibres may include loops extending around the openings, providing reinforcement thereto, and may include features shaped to aid the transmission of tangentially directed loads. As with the arrangement described with reference to FIGS. 1 to 3, the flange is of multi-layered form, each of which is stitched with a reinforcing fibre that extends onto a peripheral region which, during moulding, is bent to be angled relative to a main plane of the flange so that the reinforcing fibre of each layer is presented, in use, towards, in this case, the outer surface of a shaft to which the flange is press fitted.

The flange may, depending upon the materials used and its design, be capable of flexing, accommodating misalignment between the shaft and the component to which the flange is secured.

The arrangements described hereinbefore are merely example embodiments of the invention and it will be appreciated that a wide range of modifications and alterations may be made thereto without departing from the scope of the invention as defined by the appended claims.

1. A structural web comprising a fabric material element that has been stitched or embroidered with a reinforcing fiber, the fabric material element defining a peripheral region, and the reinforcing fiber extending onto the peripheral region, the fabric material element and reinforcing fiber being bent to take on a non-planar form with the peripheral region angled to a main plane of the element to define an engagement face for cooperation with another component, and upon which at least part of the reinforcing fiber is located.

2. A structural web according to claim 1, wherein the peripheral region is adjacent the outer periphery of the element, the reinforcing fiber on the peripheral region cooperating, in use, with an inwardly facing surface of one of an outer ring and rim component carried by the structural web.

3. A structural web according to claim 1, wherein the peripheral region is located adjacent inner periphery of the element, the reinforcing fiber on the peripheral region cooperating, in use, with an outwardly facing surface of an inner hub.

4. A structural web according to claim 1, wherein the fabric material element comprises a plurality of layers stacked upon one another, a plurality of the layers being stitched or embroidered.

5. A structural web according to claim 1, wherein the reinforcing fiber extends in a generally radial direction of the element.

6. A structural web according to claim 1, wherein an additional reinforcing fiber is additionally stitched or embroidered in a pattern defining a ring.

7. A structural web according to claim 1, wherein the reinforcing fiber is of at least one of carbon fiber, glass fiber, aramid, natural fiber and ceramic material form.

8. A method of manufacture of a structural web comprising locating a fabric material element within a mould, the fabric material element having been stitched or embroidered with a reinforcing fiber, the fabric material element defining a peripheral region, and the reinforcing fiber extending onto the peripheral region, and bending the fabric material element to take on a non-planar form with the peripheral region angled to a main plane of the element to define an engagement face for cooperation with another component, and upon which at least part of the reinforcing fiber is located.

9. A structural web according to claim 1, comprised in a gear, the gear comprising a central hub, an outer ring, and the structural web to interconnect the central hub and the outer ring.

10. A structural web according to claim 1, comprised in a connecting flange, the flange comprising at least one opening for connection to another component to be provided.
